(19) United States
(12) Patent Application Publication
(10) Pub. No.: US 2010/0259671 A1
(43) Pub. Date: Oct. 14, 2010

(54) PAN AND TILT HEADS HAVING DUAL DAMPING

(76) Inventors: Richard Arthur LINDSAY, Kenton (GB); Andrew Derek MURROW, Bury St Edmunds (GB)

Correspondence Address: FELLERS SNIDER BLANKENSHIP;BAILEY & TIPPENS, THE KENNEDY BUILDING, 321 SOUTH BOSTON SUITE 800, TULSA, OK, 74103-3318, US

(21) Appl. No.: 12/753,737

(22) Filed: Apr. 2, 2010

(30) Foreign Application Priority Data
Apr. 9, 2009 (GB) 0906314.0

(51) Int. Cl. H04N 5/225

(52) U.S. Cl. 348/373; 348/E05.025

(57) ABSTRACT

A pan and tilt head provides rotation for a T.V., video or cine camera supported on the head in pan and tilt axes. The head has first rotary damping means for controlling pan movement of the head and second rotary damping means for controlling tilt movement of the head. Both rotary damping means comprises a first rotary damper which generates a rotary damping torque which increases at a progressively reducing rate with angular velocity and a second rotary damper which generates a rotary damping torque which increases linearly with angular velocity. For each axis of movement of the head, one of the rotary dampers provides a permanent damping mode and the other rotary damper provides a selectable damping mode. A mechanism is provided for coupling the rotary dampers together in parallel to combine the damping torques imposed on movement of the head when required.

### CROSS-REFERENCE TO RELATED APPLICATIONS

The application claims priority to United Kingdom Patent Application No. 0906314.0 filed 9 Apr. 2009 which is incorporated herein by specific reference.

### BACKGROUND TO THE INVENTION

1. Field of the invention

This invention relates to pan and tilt heads for cameras and in particular video and/or cine cameras for supporting such cameras on stands such as tripods or pedestals.

2. Description of the prior art

UK Patent No. 2189042 discloses a tiltable mounting for a camera such as a television or cine camera comprising a base, a tiltable support member pivoted to the base and a reactionary moment producing means providing moments equal to the out of balance movement produced as the centre of gravity of an article mounted on the support member rotates from the upright about a horizontal axis. The reactionary moment producing means may comprise a spring located on guide means and compressible by a compression device located on a pivotal slide supported on an offset bearing.

British Patent No. 2282863 discloses a damper for damping rotary movement in a mounting such as that described above. The damper has a stator having a multiplicity of upstanding concentric fins and a rotor having a corresponding multiplicity of concentric annular fins projecting downwardly to interleave with clearance with the upstanding fins of the stator. The space between the fins is filled with viscous fluid to provide a resistance to relative movement between the rotor and stator. The rotor can be adjusted with respect to the stator by a motor driven lead screw to vary the overlap between the fins of the stator and the fins of the rotor and thereby vary the resistance provided by the damper. A speed sensor measures speed of the rotor with respect to the stator and torque applied to the camera by the hand control to panel tilt the camera is measured by a strain gauge associated with the hand control. A control system is provided for the motor embodying a microprocessor preprogrammed with one or more algorithms coordinating torque and speed. Thus the viscous damper can be controlled to provide a resistance torque to movement which rises generally linearly with speed as detected by the speed sensor to a certain level whereafter the resistance is maintained constant.

European Patent Publication No. 0850032 discloses another form of rotary damper for use in video or cine camera mountings of the form described above. In this case the damper comprises relatively rotatable members one of which has closely spaced, thin-walled flexible annular plates peripherally mounted on the member to provide annular running faces and a viscous fluid filling the spaces between the plates and the other member has a stack of segmental plates having part-annular running faces interleaved with the annular plates of the first member to slide between the plates. Slits in the annular plates permit release of viscous fluid from between the plates as fluid pressure rises ahead of the segmental plates with increasing relative speed between the members. The flexibility of the plates enables the damping characteristic of the device to be varied between viscous drag between the relative running surfaces of the annular and segmental plates at low relative speeds and, with loss of viscous fluid from between the plates, a change to boundary lubrication between the running surfaces of the plates at higher speeds can take place.

French Patent Publication No. 2354505 discloses a further form of pivoting mounting for a camera with a damper which creates a viscous resistance to rotation to control pivotal movement of the head.

### SUMMARY OF THE INVENTION

The invention provides a pan and tilt head for a camera providing rotation of a camera supported on the head in pan and tilt axes, the head having first rotary damping means for controlling said pan movement of the head and second rotary damping means for controlling tilt movement of the head, the rotary damping means comprising a first rotary damper which generates a rotary damping torque which increases at a progressively reducing rate with angular velocity and a second rotary damper which generates a rotary damping torque which increases linearly with angular velocity, and a mechanism for coupling the rotary dampers together in parallel to combine the effects of the dampers when required.

More specifically for each axis of movement of the head, one of the rotary dampers provides a permanent damping mode and the other rotary damper provides a selectable damping mode.

In the latter arrangement the permanent damping mode for the or each axis may be a mode in which a rotary damping torque increases at a progressively reducing rate with angular velocity and the selectable damping mode provides a rotary damping torque which increases linearly with angular velocity.

In any of the above arrangements the or each axis may have a rotary shaft which rotates with pan or tilt movement of the head and each damping mode may be provided by a damping unit having a rotor which rotates with the shaft and a stator which is non-rotating, the damping being provided between the respective rotors and stators.

More specifically the rotor of one damping unit may be secured to rotate with the shaft and the rotor of the other damping unit is selectively coupled by a clutch to rotate with the shaft.

For example the clutch between the shaft and rotor of the selectively couplable damping unit may be engaged by axial movement of the shaft.

In the latter arrangements each damping unit may have a viscous fluid acting between the rotor and stator of the damping unit.

In one particular arrangement the damping units may share a common chamber containing viscous fluid acting between the respective rotors and stators of the damping units.

The foregoing has outlined in broad terms the more important features of the invention disclosed herein so that the detailed description that follows may be more clearly understood, and so that the contribution of the instant inventors to the art may be better appreciated. The instant invention is not limited in its application to the details of the construction and to the arrangements of the components set forth in the following description or illustrated in the drawings. Rather the invention is capable of other embodiments and of being practiced and carried out in various other ways not specifically enumerated herein. Additionally, the disclosure that follows is intended to apply to all alternatives, modifications and equivalents as may be included within the spirit and the scope of the invention as defined by the appended claims. Further, it should be understood that the phraseology and terminology employed herein are for the purpose of description and should not be regarded as limiting, unless the specification specifically so limits the invention.

### BRIEF DESCRIPTION OF THE DRAWINGS

FIG. 1 is a perspective view of a pan and tilt head for a video camera for supporting the camera on a tripod or pedestal mounting;

FIG. 2 is a perspective view of a known form of balancing mechanism for tilt movement of the head of FIG. 1;

FIG. 3 is a sectional view through a damping arrangement for pan movement of the head in which two damping units are combined one of which provides a torque which increases at a progressively reducing rate with angular velocity and the other of which provides a torque which increases linearly with angular velocity;

FIGS. 4 to 6 show the rotary damper which provides a progressively reducing torque with increasing speed in greater detail;

FIG. 7 shows a part of the damper which provides a linearly increasing torque with speed in greater detail;

FIG. 8 is a graph showing torque plotted against angular velocity for the damper which provides a progressively reducing torque with increasing angular velocity;

FIG. 9 is a graph showing torque plotted against angular velocity for the rotary damper which provides a linearly increasing torque with angular velocity; and

FIG. 10 is a graph showing the individual torque characteristics for both dampers plotted on the same graph and a plot of the combined characteristics showing the effect of coupling the two dampers in series.

### DETAILED DESCRIPTION OF A PREFERRED EMBODIMENT

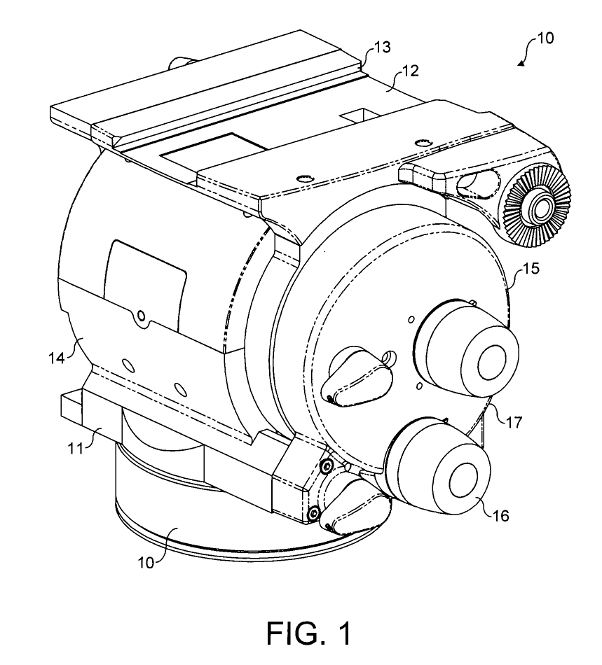

Referring firstly to FIG. 1 of the drawings, there is shown a pan and tilt head for mounting a video camera (not shown) on a tripod or pedestal (also not shown). The head comprises an annular base 10 on which a chassis 11 is mounted for rotation about a vertical axis to provide pan movement of the head with respect to the base. The chassis has a part annular, upstanding housing 12 in which damping devices for damping pan and tilt movement of the head are located together with a balancing mechanism for counter-balancing tilting of the head with a camera unit in any position to which it is rotated.

The chassis 11 also has outer, part annular side walls 13 spaced apart from the sides of the housing. A platform 14 for receiving a camera has dependent side plates 15 which slot between the housing 12 and side walls 13 of the head and are supported in bearings (not shown) for tilting of the platform about a horizontal axis. The platform 14 has a conventional slideway 16 in which a slide attached to the underbody of a camera may be located and clamped in a required position along the slideway. The side plates of the platform are coupled to the damping and balancing devices referred to earlier to control tilt movement of the platform.

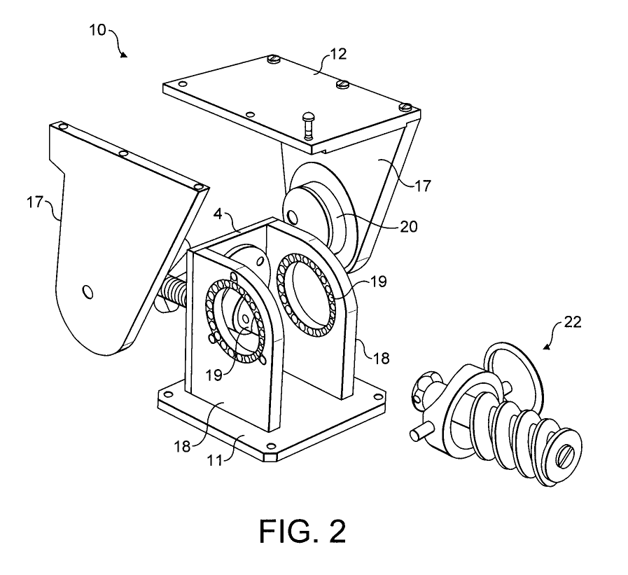

Reference is now made to FIG. 2 of the drawings which shows diagrammatically one arrangement for mounting the platform 14 of the head on the chassis 11. The chassis 11 has a pair of upstanding walls 17 in which annular bearings 18 are mounted and the dependent side plates 15 of the platform have inwardly projecting hubs 20 which engage in the bearings to support the platform for rotation about the horizontal axis. FIG. 2 of the drawings also shows a powerful coil spring operated balancing mechanism indicated at 22 which acts between the platform and base to provide a counterbalancing force for the platform/camera throughout the range of tilt of the platform so that the platform is fully counterbalanced in any position to which it is moved by the camera operator. Reference should be made to our UK Patent Publication No. 2189042, incorporated herein, for further details of the counterbalancing mechanism.

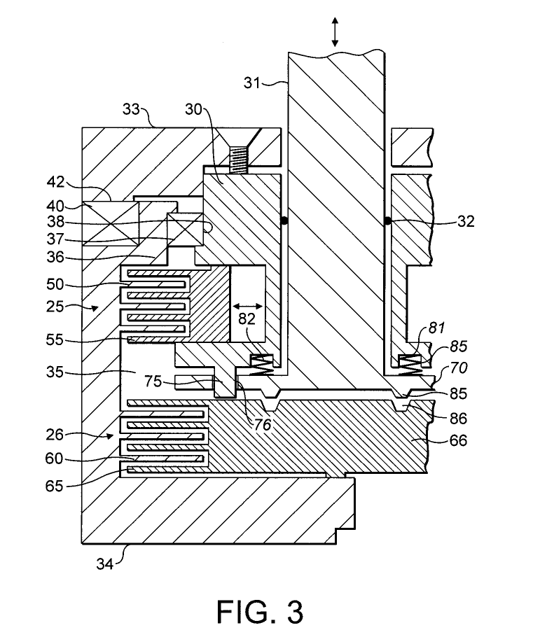

FIG. 3 of the drawings shows details of the rotary damping arrangement comprising dual rotary dampers for providing damping control to pan movement of the head about a vertical axis. The dual dampers comprise an upper, adjustable permanently engaged damper 25 of the form described and illustrated in our European Patent Publication No. 0850382 to which reference should be made and a lower non-adjustable damper 26 which is selectably engageable.

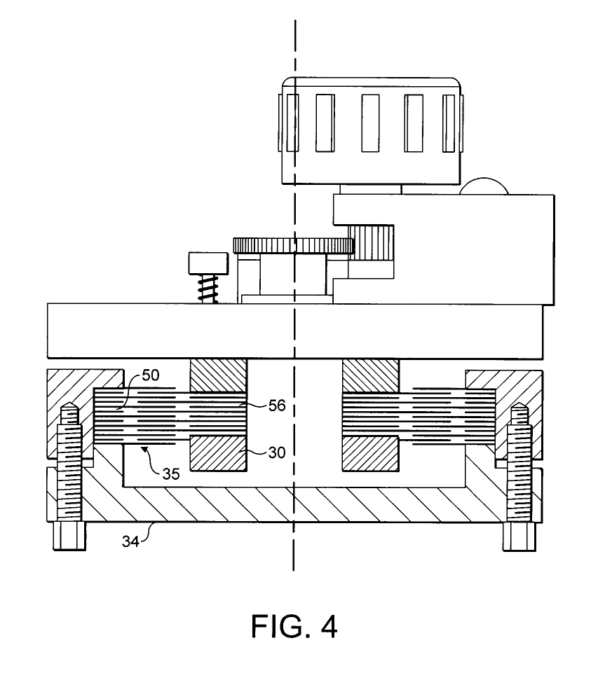

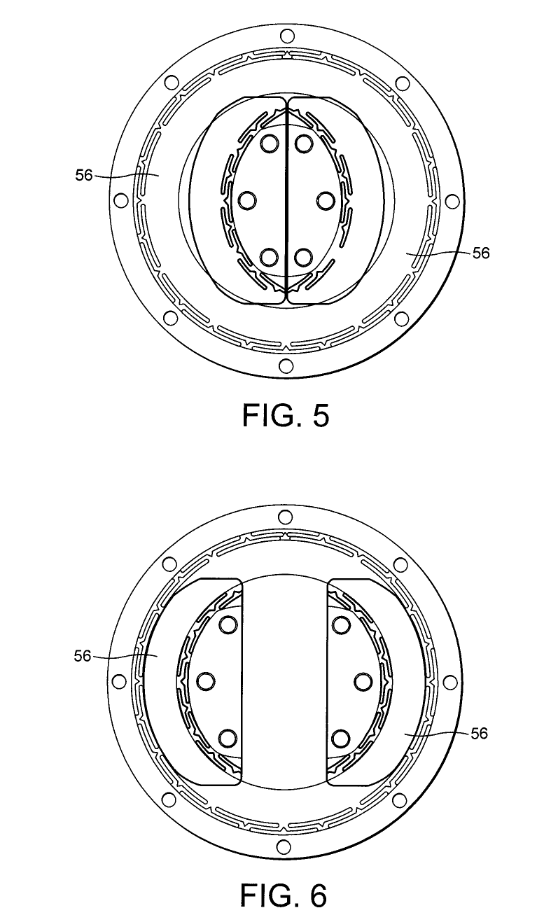

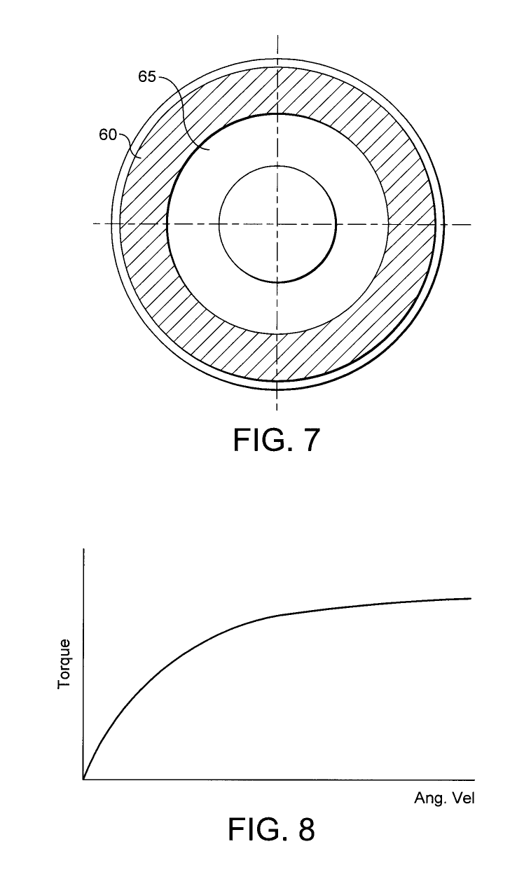

The upper damper comprises a hollow stator 30 through which a shaft 31 extends with a seal 32 between the shaft and stator. One end of the stator has an annular wall 33 secured to the stator. The damper further comprises a hollow rotor 34 having a chamber 35 into which the stator projects. The rotor 34 has a hub 36 at one end which is supported for rotation by a bearing 37 which engages in an outer seat 38 on the stator and an inner seat 39 on the hub. A further bearing 40 is mounted in an outer seat 41 formed on the rotor and a seat 42 formed on the end wall 33. FIGS. 4 to 6 of the drawings illustrate the adjustable rotary damper 25 in greater detail.

Briefly the rotor 34 has a stack of closely spaced, thin walled flexible annular plates 50 mounted around the inner periphery of the rotor casing and a viscous fluid fills the chamber 35 and the spaces between the plates. The stator has a corresponding stack 55 of said metal plates 56 having part annular running faces interleaved with the annular plates 50 to slide between the plates with relative rotation of the rotor and stator. Slits are provided in the annular plates (see FIG. 4) to permit release of viscous fluid from between the plates as pressure rises ahead of the segmental plates with increasing relatively speed between the rotor and stator. The flexibility of the annular plates allows the plates to close together accommodating of viscous fluid from between the plates whereby the damping characteristic of the device can vary between viscous drag between the plates at low relative speeds and, with loss of viscous fluid between the plates, can change to boundary lubrication between the running surfaces at higher speeds. Moreover, the stack of segmental plates mounted on the stator can be adjusted radially of the stator by the mechanism shown in FIGS. 4 to 6 and described in greater detail in our European Patent Specification as referred to above to vary the extent of drag provided between the plates at any particular speed.

The second, non-adjustable rotary damper 26 is provided in the same chamber 35 below the first damper and comprises a further set of annular plates 60 mounted on the inner side of the rotor and a set of annular plates 65 mounted on a further stator 66 in the chamber. The shaft 31 referred to above projects through the stator 30 and terminates in an end plate 70. The plate is locked to the stator against relative rotation with respect to the stator whilst being permitted to move up and down with respect to the stator by means of a post on the stator engaging in an aperture 76 in the plate. Moreover, the plate is biased downwardly away from the stator by means of coil springs 80 located in seats 81,82 between the end of the stator and the upper surface of the plate. The under surface of the plate has a ring of teeth 85 which are engageable with corresponding teeth 86 in the upper side of the head of the lower damper to lock the head to the plate and thereby prevent the plate from rotating. The shaft is moved vertically in the stator to lock and release the plate from the head of the lower damper by a mechanism (not shown) to enable the damper to be selectably engaged and disengaged.

Reference is now made to FIG. 8 which is a graph depicting the torque provided by the upper damper plotted against and angular velocity. It will be seen, and as explained in more detail in our European Patent Publication No. 0850382, that the damper 25 provides a resistance torque to rotation of the rotor which rises at a progressively reducing rate with increasing angular velocity of the rotor with respect to the stator. This form of damping is preferred for use in controlling pan (and tilt) movement of a video camera in which the operator requires an initial resistance to pan movement of the camera which rises as the speed of the camera rises but which rises at a progressively reducing rate so that once a certain speed has been reached, the resistance provided by the damper to rotation does not increase. As indicated above, the plates on the stator can be adjusted to vary the extent to which they interleave with the plates on the rotor to adjust the overall degree of resistance or torque opposing rotation of the rotor as required by the camera operator. The effect of the latter adjustment is therefore simply to move the curved line shown in FIG. 8 upwardly or downwardly.

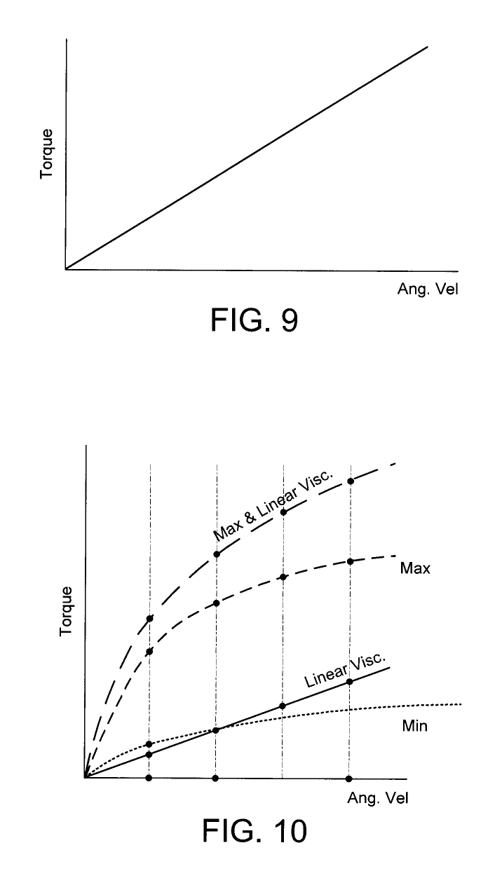

The lower damper 26 shown in FIG. 3 has annular plates on the stator and rotor with a fixed overlap and the plates are relatively stiff and no provision is made for releasing the viscous fluid from between the plates so that the damper provides a viscous drag throughout its range of speed and does not revert to boundary lubrication at higher speeds. As a result, the graph of torque plotted against angular velocity for the lower damper is a simple straight line as shown in FIG. 9. Such an arrangement is preferred for camera mounting heads for “cine” (or motion picture) cameras.

To meet a need for an arrangement which can provide both the “whip pan” characteristic of the upper damper and, when required, a “linear viscous” characteristic as provided by the lower damper, the mechanism for coupling the stator part of the lower damper to the shaft is utilised. When the lower damper is brought into operation by engagement of the shaft plate with the head of the lower damper, both dampers operate in parallel and provide and modified torque/angular velocity characteristic as shown in FIG. 10 in which it will be seen that the normal characteristic of the “whip pan” damper in which torque rises to a certain level and then flattens out is modified and instead rises at a progressively reducing rate to a certain level and then continues to rise linearly with increasing annular velocity under the influence of the lower “linear viscous” damper.

Thus the arrangement in the invention provides the characteristics of the whip pan damper with or without the linear viscous damper as required. The dual damper arrangement can be provided in the pan movement of the camera only for both pan and tilt movements as required.

Thus, the present invention is well adapted to carry out the objects and attain the ends and advantages mentioned above as well as those inherent therein. While the inventive device has been described and illustrated herein by reference to certain preferred embodiments in relation to the drawings attached thereto, various changes and further modifications, apart from those shown or suggested herein, may be made therein by those skilled in the art, without departing from the spirit of the inventive concept the scope of which is to be determined by the following claims.

1. A pan and tilt head for a camera providing rotation of a camera supported on the head in pan and tilt axes, the head having first rotary damping means for controlling pan movement of the head and second rotary damping means for controlling tilt movement of the head, both rotary damping means comprising a first rotary damper which generates a rotary damping torque which increases at a progressively reducing rate with angular velocity and a second rotary damper which generates a rotary damping torque which increases linearly with angular velocity, and a mechanism for coupling the rotary dampers together in parallel to combine the damping torques imposed on movement of the head when required.

2. A pan and tilt head as claimed in claim 1, wherein, for each axis of movement of the head, one of the rotary dampers provides a permanent damping mode and the other rotary damper provides a selectable damping mode.

3. A pan and tilt head as claimed in claim 2, wherein the permanent damping mode for the or each axis is a mode in which a rotary damping torque increases at a progressively reducing rate with angular velocity and the selectable damping mode provides a rotary damping torque which increases linearly with angular velocity.

4. A pan and tilt head as claimed in claim 1, wherein the or each axis has a rotary shaft which rotates with pan or tilt movement of the head and each damping mode is provided by a damping unit having a rotor which rotates with the shaft and a stator which is non-rotating, the damping being provided between the respective rotors and stators.

5. A pan and tilt head as claimed in claim 4, wherein the rotor of one damping unit is fixed to rotate with the shaft and the rotor of the other damping unit is selectively coupled by a clutch to rotate with the shaft.

6. A pan and tilt head as claimed in claim 5, wherein the clutch between the shaft and rotor of the selectively couplable damping unit is engaged by axial movement of the shaft.

7. A pan and tilt head as claimed in claim 5, wherein each damping unit has a viscous fluid acting between the rotor and stator of the damping unit.

8. A pan and tilt head as claimed in claim 7, wherein the damping units share a common chamber containing viscous fluid acting between the respective rotors and stators of the damping units.

9. A pan and tilt head as claimed in claim 1, wherein said one damping means is adjustable to vary the rotary damping torque provided.
